(19) United States
(12) Patent Application Publication
(10) Pub. No.: US 2022/0373771 A1
(43) Pub. Date: Nov. 24, 2022

(54) Optical Imaging Lens Assembly

(71) Applicant: ZHEJIANG SUNNY OPTICS CO., LTD., Ningbo, Zhejiang (CN)

(72) Inventors: Yi ZHANG, Ningbo, Zhejiang (CN); Kaiyuan ZHANG, Ningbo, Zhejiang (CN); Fujian DAI, Ningbo, Zhejiang (CN); Liefeng ZHAO, Ningbo, Zhejiang (CN)

(21) Appl. No.: 17/641,443

(22) PCT Filed: Jul. 24, 2020
(86) PCT No.: PCT/CN2020/104459

§ 371 Date: Mar. 9, 2022

(30) Foreign Application Priority Data
Sep. 12, 2019 (CN) 201910865155.4

(51) Int. Cl. G02B 13/00; G02B 9/34

(52) U.S. Cl. CPC G02B 13/004; G02B 9/34

(57) ABSTRACT

The disclosure provides an optical imaging lens assembly, which sequentially includes from an object side to an image side along an optical axis: a first lens with a refractive power, a second lens with a refractive power, a third lens with a negative refractive power, and a fourth lens with a positive refractive power. A total effective focal length f of the optical imaging lens assembly satisfies 20 mm<f<30 mm.

### CROSS-REFERENCE TO RELATED PRESENT INVENTION(S)

The disclosure claims priority to and the benefit of Chinese Patent Present invention No. 201910865155.4, filed in the China National Intellectual Property Administration (CNIPA) on 12 Sep. 2019, which is incorporated herein by reference in its entirety.

### TECHNICAL FIELD

The disclosure relates to the technical field of optical elements, and particularly to an optical imaging lens assembly.

### BACKGROUND

With the popularization of portable electronic products such as mobile phones and tablet computers, requirements of users on the imaging quality thereof have also increased. Meanwhile, a currently emerging dual-camera technology usually needs a telephoto lens to achieve a relatively high spatial angular resolution.

In order to satisfy market development requirements of portable electronic products such as mobile phones and tablet computers, an imaging lens assembly needs to use as few lenses as possible to reduce the total length of the lens, which, however, reduces the degree of design freedom and makes it difficult to satisfy a requirement on the imaging quality.

### SUMMARY

An embodiment of the disclosure provides an optical imaging lens assembly, which sequentially includes from an object side to an image side along an optical axis, a first lens with a refractive power, a second lens with a refractive power, a third lens with a negative refractive power, and a fourth lens with a positive refractive power.

In an implementation mode, a total effective focal length f of the optical imaging lens assembly may satisfy 20 mm<f<30 mm.

In an implementation mode, TTL is a distance from an object-side surface of the first lens to an imaging surface of the optical imaging lens assembly on the optical axis, and a total effective focal length f of the optical imaging lens assembly and TTL may satisfy TTL/f<1.2.

In an implementation mode, an effective focal length f3 of the third lens, an effective focal length f4 of the fourth lens and a total effective focal length f of the optical imaging lens assembly may satisfy 0.1<(f3+f4)/f<0.6.

In an implementation mode, a curvature radius R7 of an object-side surface of the fourth lens and a curvature radius R6 of an image-side surface of the third lens may satisfy 0.3<(R7−R6)/(R7+R6)<0.7.

In an implementation mode, a curvature radius R1 of an object-side surface of the first lens and a curvature radius R2 of an image-side surface of the first lens may satisfy 0.1<R1/R2<1.3.

In an implementation mode, a refractive index N1 of the first lens, a refractive index N2 of the second lens, a refractive index N3 of the third lens and a refractive index N4 of the fourth lens may satisfy 1.8<(N1+N2+N3+N4)/4<2.1.

In an implementation mode, a spacing distance T12 of the first lens and the second lens on the optical axis, a spacing distance T23 of the second lens and the third lens on the optical axis, a spacing distance T34 of the third lens and the fourth lens on the optical axis, a center thickness CT1 of the first lens on the optical axis, a center thickness CT2 of the second lens on the optical axis and a center thickness CT3 of the third lens on the optical axis may satisfy 0.2<(T12+T23+T34)/(CT1+CT2+CT3)<0.8.

In an implementation mode, the optical imaging lens assembly may further include a diaphragm. SL is a distance from the diaphragm to an imaging surface of the optical imaging lens assembly on the optical axis, TTL is a distance from an object-side surface of the first lens to the imaging surface on the optical axis, and SL and TTL may satisfy 0.8<SL/TTL<1.0.

In an implementation mode, BFL is a distance from an image-side surface of the fourth lens to an imaging surface of the optical imaging lens assembly on the optical axis, and BFL and the total effective focal length f of the optical imaging lens assembly may satisfy 0.65<BFL/f<0.85.

In an implementation mode, SAG11 is a distance from an intersection point of an object-side surface of the first lens and the optical axis to an effective radius vertex of the object-side surface of the first lens on the optical axis, SAG12 is a distance from an intersection point of an image-side surface of the first lens and the optical axis to an effective radius vertex of the image-side surface of the first lens on the optical axis, ImgH is a half of a diagonal length of an effective pixel region on an imaging surface of the optical imaging lens assembly, and SAG11, SAG12 and ImgH may satisfy 0.4<(SAG11+SAG12)/ImgH<1.3.

In an implementation mode, SAG41 is a distance from an intersection point of an object-side surface of the fourth lens and the optical axis to an effective radius vertex of the object-side surface of the fourth lens on the optical axis, SAG42 is a distance from an intersection point of an image-side surface of the fourth lens and the optical axis to an effective radius vertex of the image-side surface of the fourth lens on the optical axis, and SAG41, SAG42 and a center thickness CT4 of the fourth lens on the optical axis may satisfy 0.5<(SAG41−SAG42)/CT4<0.7.

In an implementation mode, at least two lenses of the first lens to the fourth lens may be made of a glass material.

In an implementation mode, object-side surfaces and image-side surfaces of at least two lenses of the first lens to the fourth lens may be spherical.

In an implementation mode, FOV is a maximum field of view of the optical imaging lens assembly, and FOV may satisfy FOV<15°.

According to the disclosure, four lenses are adopted, and the refractive powers and surface types of each lens, the center thicknesses of each lens, on-axis spacing distances between the lenses and the like are configured reasonably to achieve at least one of beneficial effects of excessively large focal length, high resolution, high imaging quality and the like of the optical imaging lens assembly.

### BRIEF DESCRIPTION OF THE DRAWINGS

The other features, objectives and advantages of the disclosure become more apparent upon reading detailed descriptions made to unrestrictive embodiment s with reference to the following drawings.

FIG. 1 shows a structural schematic diagram of an optical imaging lens assembly according to Embodiment 1 of the disclosure; FIGS. 2A-2C show a longitudinal aberration curve, an astigmatism curve and a distortion curve of an optical imaging lens assembly according to Embodiment 1 respectively;

FIG. 3 shows a structural schematic diagram of an optical imaging lens assembly according to Embodiment 2 of the disclosure; FIGS. 4A-4C show a longitudinal aberration curve, an astigmatism curve and a distortion curve of an optical imaging lens assembly according to Embodiment 2 respectively;

FIG. 5 shows a structural schematic diagram of an optical imaging lens assembly according to Embodiment 3 of the disclosure; FIGS. 6A-6C show a longitudinal aberration curve, an astigmatism curve, and a distortion curve of an optical imaging lens assembly according to Embodiment 3 respectively;

FIG. 7 shows a structural schematic diagram of an optical imaging lens assembly according to Embodiment 4 of the disclosure; FIGS. 8A-8C show a longitudinal aberration curve, an astigmatism curve and a distortion curve of an optical imaging lens assembly according to Embodiment 4 respectively;

FIG. 9 shows a structural schematic diagram of an optical imaging lens assembly according to Embodiment 5 of the disclosure; FIGS. 10A-10C show a longitudinal aberration curve, an astigmatism curve and a distortion curve of an optical imaging lens assembly according to Embodiment 5 respectively;

FIG. 11 shows a structural schematic diagram of an optical imaging lens assembly according to Embodiment 6 of the disclosure; FIGS. 12A-12C show a longitudinal aberration curve, an astigmatism curve and a distortion curve of an optical imaging lens assembly according to Embodiment 6 respectively;

FIG. 13 shows a structural schematic diagram of an optical imaging lens assembly according to Embodiment 7 of the disclosure; and FIGS. 14A-14C show a longitudinal aberration curve, an astigmatism curve and a distortion curve of an optical imaging lens assembly according to Embodiment 7 respectively.

### DETAILED DESCRIPTION OF THE EMBODIMENTS

In order to understand the disclosure better, more detailed descriptions will be made to each aspect of the disclosure with reference to the drawings. It is to be understood that these detailed descriptions are only descriptions about the exemplary embodiment s of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, the expressions of first, second, third and the like are only used to distinguish one feature from another feature and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It should also be understood that terms “include”, “including”, “have”, “contain”, and/or “containing”, used in the specification, represent existence of a stated feature, component and/or part but do not exclude existence or addition of one or more other features, components and parts and/or combinations thereof. In addition, expressions like “at least one in . . . ” may appear after a list of listed features not to modify an individual component in the list but to modify the listed features. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by those of ordinary skill in the art of the disclosure. It is also to be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and features in the embodiments may be combined without conflicts. The disclosure will be described below with reference to the drawings and in combination with the embodiments in detail.

The features, principles and other aspects of the disclosure will be described below in detail.

An optical imaging lens assembly according to an exemplary embodiment of the disclosure may include, for example, four lenses with refractive powers, i.e., a first lens, a second lens, a third lens and a fourth lens respectively. The four lenses are sequentially arranged from an object side to an image side along an optical axis. There may be a spacing distance between any two adjacent lenses in the first lens to the fourth lens.

In the exemplary embodiment, the third lens may have a negative refractive power, and the fourth lens may have a positive refractive power.

In the exemplary embodiment, the optical imaging lens assembly according to the disclosure may satisfy 20 mm<f<30 mm, wherein f is a total effective focal length of the optical imaging lens assembly. More specifically, f may further satisfy 26 mm<f<30 mm. Satisfying 20 mm<f<30 mm is favorable for achieving a feature of excessively large focal length of the optical imaging lens assembly at the same time of ensuring the miniaturization of the optical imaging lens assembly.

In the exemplary embodiment, the optical imaging lens assembly according to the disclosure may satisfy TTL/f<1.2, wherein f is a total effective focal length of the optical imaging lens assembly, and TTL is a distance from an object-side surface of the first lens to an imaging surface of the optical imaging lens assembly on the optical axis. More specifically, TTL and f may further satisfy TTL/f<1.1. Satisfying TTL/f<1.2 is favorable for ensuring the miniaturization of the optical imaging lens assembly. In combination with conditional expression 20 mm<f<30 mm, a feature of excessively large focal length may be achieved at the same time of ensuring the miniaturization of the optical imaging lens assembly.

In the exemplary embodiment, the optical imaging lens assembly according to the disclosure may satisfy 0.1<(f3+f4)/f<0.6, wherein f3 is an effective focal length of the third lens, f4 is an effective focal length of the fourth lens, and f is a total effective focal length of the optical imaging lens assembly. More specifically, f3, f4 and f may further satisfy 0.2<(f3+f4)/f<0.5. 0.1<(f3+f4)/f<0.6 is satisfied, so that spherical aberration and coma contributions of the third lens and the fourth lens may be restricted reasonably to further achieve reasonable sensitivity of the third lens and the fourth lens.

In the exemplary embodiment, the optical imaging lens assembly according to the disclosure may satisfy 0.3<(R7−R6)/(R7+R6)<0.7, wherein R7 is a curvature radius of an object-side surface of the fourth lens, and R6 is a curvature radius of an image-side surface of the third lens. 0.3<(R7−R6)/(R7+R6)<0.7 is satisfied, so that astigmatism contributions of the object-side surface of the fourth lens and the image-side surface of the third lens may be controlled effectively to further control the image quality in a middle field of view and an aperture band of the optical imaging lens assembly effectively and reasonably.

In the exemplary embodiment, the optical imaging lens assembly according to the disclosure may satisfy 0.1<R1/R2<1.3, wherein R1 is a curvature radius of an object-side surface of the first lens, and R2 is a curvature radius of an image-side surface of the first lens. 0.1<R1/R2<1.3 is satisfied, so that the shape of the first lens may be restricted effectively, and furthermore, aberration contribution rates of the object-side surface and the image-side surface of the first lens may be controlled effectively to balance an aperture band related aberration of the optical imaging lens assembly and improve the imaging quality of the optical imaging lens assembly.

In the exemplary embodiment, the optical imaging lens assembly according to the disclosure may satisfy 1.8<(N1+N2+N3+N4)/4<2.1, wherein N1 is a refractive index of the first lens, N2 is a refractive index of the second lens, N3 is a refractive index of the third lens, and N4 is a refractive index of the fourth lens. More specifically, N1, N2, N3 and N4 may further satisfy 1.8<(N1+N2+N3+N4)/4<2.0. 1.8<(N1+N2+N3+N4)/4<2.1 is satisfied, so that the refractive powers of each lens may be configured effectively to achieve a relatively good temperature drift elimination effect at the same time of achieving relatively high image quality of the optical imaging lens assembly.

In the exemplary embodiment, the optical imaging lens assembly according to the disclosure may satisfy 0.2<(T12+T23+T34)/(CT1+CT2+CT3)<0.8, wherein T12 is a spacing distance of the first lens and the second lens on the optical axis, T23 is a spacing distance of the second lens and the third lens on the optical axis, T34 is a spacing distance of the third lens and the fourth lens on the optical axis, CT1 is a center thickness of the first lens on the optical axis, CT2 is a center thickness of the second lens on the optical axis, and CT3 is a center thickness of the third lens on the optical axis. More specifically, T12, T23, T34, CT1, CT2 and CT3 may further satisfy 0.25<(T12+T23+T34)/(CT1+CT2+CT3)<0.8. 0.2<(T12+T23+T34)/(CT1+CT2+CT3)<0.8 is satisfied, so that a reasonable field curvature contribution of each of fields of view of the optical imaging lens assembly may be achieved.

In the exemplary embodiment, the optical imaging lens assembly according to the disclosure may include a diaphragm configured to adjust the amount of light. The optical imaging lens assembly according to the disclosure may satisfy 0.8<SL/TTL<1.0, wherein SL is a distance from the diaphragm to an imaging surface of the optical imaging lens assembly on the optical axis, and TTL is a distance from an object-side surface of the first lens to the imaging surface of the optical imaging lens assembly on the optical axis. An appropriate diaphragm position may be selected to effectively correct a related aberration (e.g., coma, astigmatism, distortion and longitudinal aberration) of the optical imaging lens assembly. More specifically, the diaphragm may be arranged between the second lens and the third lens.

In the exemplary embodiment, the optical imaging lens assembly according to the disclosure may satisfy 0.65<BFL/f<0.85, wherein BFL is a distance from an image-side surface of the fourth lens to an imaging surface of the optical imaging lens assembly on the optical axis, and f is a total effective focal length of the optical imaging lens assembly. 0.65<BFL/f<0.85 is satisfied, so that the optical imaging lens assembly may be endowed with both an excessively large effective focal length and an excessively large back focal length, and furthermore, modules of the lens assembly may be conveniently assembled later.

In the exemplary embodiment, the optical imaging lens assembly according to the disclosure may satisfy 0.4<(SAG11+SAG12)/ImgH<1.3, wherein SAG11 is a distance from an intersection point of an object-side surface of the first lens and the optical axis to an effective radius vertex of the object-side surface of the first lens on the optical axis, SAG12 is a distance from an intersection point of an image-side surface of the first lens and the optical axis to an effective radius vertex of the image-side surface of the first lens on the optical axis, and ImgH is a half of a diagonal length of an effective pixel region on an imaging surface of the optical imaging lens assembly. More specifically, SAG11, SAG12 and ImgH may further satisfy 0.4<(SAG11+SAG12)/ImgH<1.25. 0.4<(SAG11+SAG12)/ImgH<1.3 is satisfied, so that the first lens may be prevented from being excessively bent to further reduce difficulties in machining and reduce a spherical aberration of the optical imaging lens assembly; in addition, the total effective focal length of the optical imaging lens assembly may be increased on the premise of ensuring the imaging quality of the optical imaging lens assembly; and moreover, the relative illumination of the optical imaging lens assembly may be increased to improve the imaging quality of the optical imaging lens assembly in a relatively dark environment.

In the exemplary embodiment, the optical imaging lens assembly according to the disclosure may satisfy 0.5<(SAG41−SAG42)/CT4<0.7, wherein SAG41 is a distance from an intersection point of an object-side surface of the fourth lens and the optical axis to an effective radius vertex of the object-side surface of the fourth lens on the optical axis, SAG42 is a distance from an intersection point of an image-side surface of the fourth lens and the optical axis to an effective radius vertex of the image-side surface of the fourth lens on the optical axis, and CT4 is a center thickness of the fourth lens on the optical axis. Satisfying 0.5<(SAG41−SAG42)/CT4<0.7 is favorable for ensuring the machining, forming and assembling of the fourth lens to achieve high imaging quality. An unreasonable ratio may make it difficult to debug the surface type of the fourth lens and result in a high deformation rate after assembling and further may not ensure the imaging quality.

In the exemplary embodiment, at least two lenses of the first lens to the fourth lens may be made of a glass material. The glass material is relatively wide in refractive index range and relatively high in selectivity, so that using the glass material may improve the performance of the optical imaging lens assembly effectively. Moreover, an expansion coefficient of glass is lower than that of plastic, so that using the glass material in the optical imaging lens assembly may eliminate a temperature drift better. More specifically, the first lens to the fourth lens may all be made of the glass material.

In the exemplary embodiment, object-side surfaces and image-side surfaces of at least two lenses of the first lens to the fourth lens may be spherical. Setting object-side surfaces and image-side surfaces of at least two lenses of the first lens to the fourth lens to be spherical may contribute to the machining of the optical imaging lens assembly and reduce the machining cost. More specifically, both an object-side surface and an image-side surface of each of the first lens to the fourth lens may be spherical surfaces.

In the exemplary embodiment, the optical imaging lens assembly according to the disclosure may satisfy FOV<15°, wherein FOV is a maximum field of view of the optical imaging lens assembly. More specifically, FOV may further satisfy FOV<12°. FOV<15° is satisfied, so that the focal length of the optical imaging lens assembly may be ensured in a specific range to achieve the feature of large focal length of the optical imaging lens assembly. The optical imaging lens assembly according to the disclosure may be matched with a short-focal-length wide-angle lens for use, thereby achieving a relatively high optical zoom ratio.

In an embodiment, the optical imaging lens assembly may further include an optical filter configured to correct the chromatic aberration and/or a protective glass configured to protect a photosensitive element on the imaging surface.

The disclosure discloses a four-lens glass telephoto optical imaging lens group. The refractive powers and surface types of each lens, the center thicknesses and curvature radii of each lens, the on-axis spacing distances between the lenses and the like are configured reasonably, so that the features of large focal length and high resolution of the optical imaging lens assembly may be achieved under a relatively low degree of design freedom.

However, those skilled in the art should know that the number of the lenses forming the optical imaging lens assembly may be changed without departing from the technical solutions claimed in the disclosure to achieve each result and advantage described in the specification. For example, although descriptions are made in the embodiment with four lenses as an example, the optical imaging lens assembly is not limited to four lenses. If necessary, the optical imaging lens assembly may also include another number of lenses.

Specific embodiments applicable to the optical imaging lens assembly of the above-mentioned implementation mode will further be described below with reference to the drawings.

### Embodiment 1

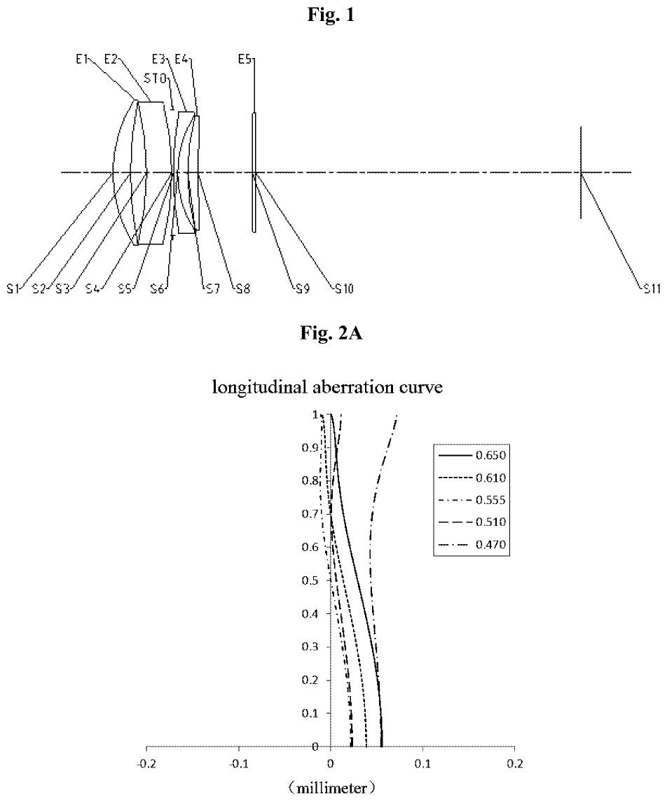

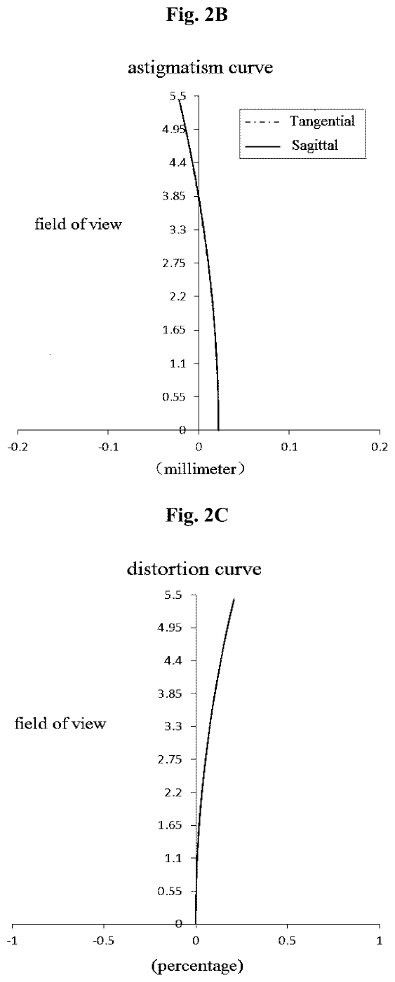

An optical imaging lens assembly according to Embodiment 1 of the disclosure will be described below with reference to FIGS. 1-2C. FIG. 1 shows a structural schematic diagram of an optical imaging lens assembly according to Embodiment 1 of the disclosure.

As shown in FIG. 1, the optical imaging lens assembly sequentially includes from an object side to an image side: a first lens E1, a second lens E2, a diaphragm STO, a third lens E3, a fourth lens E4, an optical filter E5, and an imaging surface S11.

The first lens E1 has a positive refractive power, an object-side surface S1 thereof is a convex surface, and an image-side surface S2 is a concave surface. The second lens E2 has a positive refractive power, an object-side surface S3 thereof is a concave surface, and an image-side surface S4 is a convex surface. The third lens E3 has a negative refractive power, an object-side surface S5 thereof is a convex surface, and an image-side surface S6 is a concave surface. The fourth lens E4 has a positive refractive power, an object-side surface S7 thereof is a convex surface, and an image-side surface S8 is a concave surface. The optical filter E5 has an object-side surface S9 and an image-side surface S10. Light from an object sequentially passes through each of the surfaces S1 to S10 and is finally imaged on the imaging surface S11.

Table 1 shows a basic parameter table of the optical imaging lens assembly of Embodiment 1, wherein the units of the curvature radius, the thickness/distance, the focal length and the effective semi-diameter are all millimeters (mm).

TABLE 1

| Surface | Surface | Curvature | Thickness/ | | Refractive | Abbe | Focal | Effective |
|---|---|---|---|---|---|---|---|---|
| number | type | radius | distance | Material | index | number | length | semi-diameter |
| OBJ | Spherical | Infinite | Infinite | | | | | |
| S1 | Spherical | 7.9383 | 1.0380 | Glass | 2.01 | 29.1 | 12.10 | 4.2555 |
| S2 | Spherical | 21.2868 | 0.9425 | | | | | 4.1802 |
| S3 | Spherical | −17.2703 | 1.4771 | Glass | 2.01 | 29.1 | 293.61 | 4.1716 |
| S4 | Spherical | −17.0177 | 0.0500 | | | | | 4.0302 |
| STO | Spherical | Infinite | 0.0500 | | | | | 3.7020 |
| S5 | Spherical | 20.8462 | 0.2400 | Glass | 1.93 | 20.9 | −9.60 | 3.5771 |
| S6 | Spherical | 6.2183 | 0.5859 | | | | | 3.3453 |
| S7 | Spherical | 12.6645 | 0.5992 | Glass | 1.76 | 52.3 | 21.42 | 3.3537 |
| S8 | Spherical | 56.4476 | 3.1994 | | | | | 3.3435 |
| S9 | Spherical | Infinite | 0.2100 | Glass | 1.52 | 64.2 | | 3.5000 |
| S10 | Spherical | Infinite | 19.0622 | | | | | 3.5000 |
| S11 | Spherical | Infinite | | | | | | 2.7354 |

In the embodiment, a total effective focal length f of the optical imaging lens assembly is 28.20 mm. TTL is a total length of the optical imaging lens assembly (i.e., a distance from the object-side surface S1 of the first lens E1 to the imaging surface S11 of the optical imaging lens assembly on an optical axis), and TTL is 27.45 mm. ImgH is a half of a diagonal length of an effective pixel region on the imaging surface S11 of the optical imaging lens assembly, and ImgH is 2.71 mm. FOV is a maximum field of view of the optical imaging lens assembly, and FOV is 11.0°.

FIG. 2A shows a longitudinal aberration curve of the optical imaging lens assembly according to Embodiment 1 to represent deviations of a convergence focal point after light with different wavelengths passes through the lens. FIG. 2B shows an astigmatism curve of the optical imaging lens assembly according to Embodiment 1 to represent a tangential image surface curvature and a sagittal image surface curvature. FIG. 2C shows a distortion curve of the optical imaging lens assembly according to Embodiment 1 to represent distortion values corresponding to different fields of view. According to FIGS. 2A-2C, it can be seen that the optical imaging lens assembly provided in Embodiment 1 may achieve high imaging quality.

### Embodiment 2

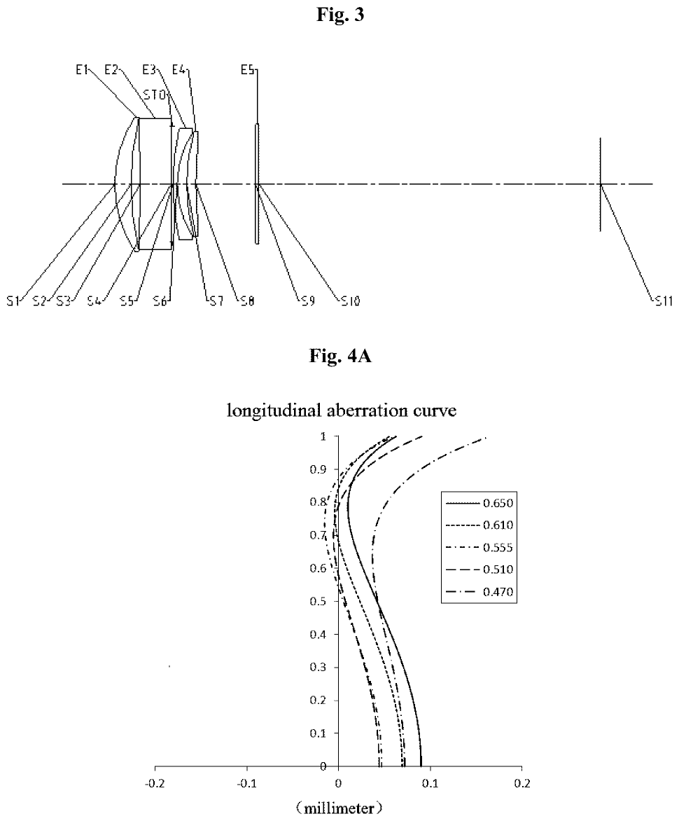

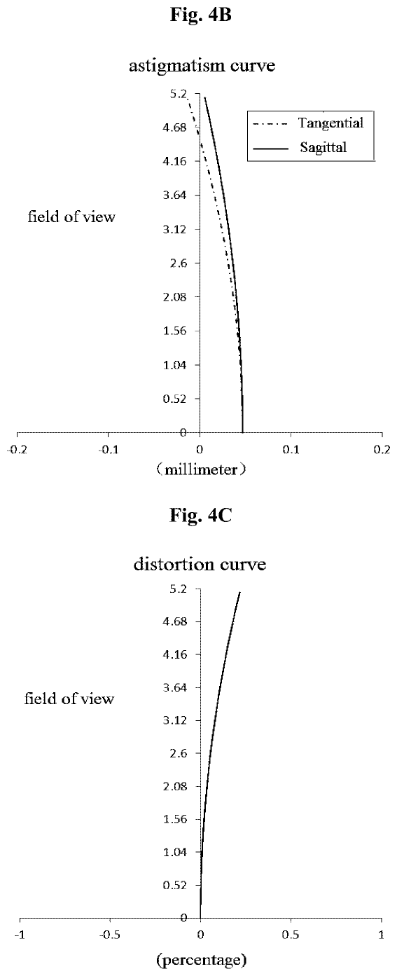

An optical imaging lens assembly according to Embodiment 2 of the disclosure will be described below with reference to FIGS. 3-4C. FIG. 3 shows a structural schematic diagram of an optical imaging lens assembly according to Embodiment 2 of the disclosure.

As shown in FIG. 3, the optical imaging lens assembly sequentially includes from an object side to an image side: a first lens E1, a second lens E2, a diaphragm STO, a third lens E3, a fourth lens E4, an optical filter E5, and an imaging surface S11.

The first lens E1 has a positive refractive power, an object-side surface S1 thereof is a convex surface, and an image-side surface S2 is a concave surface. The second lens E2 has a negative refractive power, an object-side surface S3 thereof is a concave surface, and an image-side surface S4 is a convex surface. The third lens E3 has a negative refractive power, an object-side surface S5 thereof is a convex surface, and an image-side surface S6 is a concave surface. The fourth lens E4 has a positive refractive power, an object-side surface S7 thereof is a convex surface, and an image-side surface S8 is a concave surface. The optical filter E5 has an object-side surface S9 and an image-side surface S10. Light from an object sequentially passes through each of the surfaces S1 to S10 and is finally imaged on the imaging surface S11.

In the embodiment, a total effective focal length f of the optical imaging lens assembly is 29.80 mm. TTL is a total length of the optical imaging lens assembly, and TTL is 28.00 mm. ImgH is a half of a diagonal length of an effective pixel region on the imaging surface S11 of the optical imaging lens assembly, and ImgH is 2.71 mm. FOV is a maximum field of view of the optical imaging lens assembly, and FOV is 10.4°.

Table 2 shows a basic parameter table of the optical imaging lens assembly of Embodiment 2, wherein the units of the curvature radius, the thickness/distance, the focal length and the effective semi-diameter are all millimeters (mm).

TABLE 2

| Surface | Surface | Curvature | Thickness/ | | Refractive | Abbe | Focal | Effective |
|---|---|---|---|---|---|---|---|---|
| number | type | radius | distance | Material | index | number | length | semi-diameter |
| OBJ | Spherical | Infinite | Infinite | | | | | |
| S1 | Spherical | 7.2173 | 0.9392 | Glass | 2.01 | 29.1 | 11.90 | 3.9145 |
| S2 | Spherical | 16.9583 | 0.5165 | | | | | 3.8354 |
| S3 | Spherical | −189.5810 | 1.7988 | Glass | 2.01 | 29.1 | −264.05 | 3.8168 |
| S4 | Spherical | −663.3080 | 0.0500 | | | | | 3.4298 |
| STO | Spherical | Infinite | 0.0500 | | | | | 3.3683 |
| S5 | Spherical | 15.2622 | 0.2400 | Glass | 1.93 | 20.9 | −9.67 | 3.2367 |
| S6 | Spherical | 5.6204 | 0.5535 | | | | | 3.0516 |
| S7 | Spherical | 11.6200 | 0.5251 | Glass | 1.76 | 52.3 | 22.57 | 3.0597 |
| S8 | Spherical | 35.5496 | 3.4325 | | | | | 3.0487 |
| S9 | Spherical | Infinite | 0.2100 | Glass | 1.52 | 64.2 | | 3.5000 |
| S10 | Spherical | Infinite | 19.6845 | | | | | 3.5000 |
| S11 | Spherical | Infinite | | | | | | 2.7401 |

FIG. 4A shows a longitudinal aberration curve of the optical imaging lens assembly according to Embodiment 2 to represent deviations of a convergence focal point after light with different wavelengths passes through the lens. FIG. 4B shows an astigmatism curve of the optical imaging lens assembly according to Embodiment 2 to represent a tangential image surface curvature and a sagittal image surface curvature. FIG. 4C shows a distortion curve of the optical imaging lens assembly according to Embodiment 2 to represent distortion values corresponding to different fields of view. According to FIGS. 4A-4C, it can be seen that the optical imaging lens assembly provided in Embodiment 2 may achieve high imaging quality.

### Embodiment 3

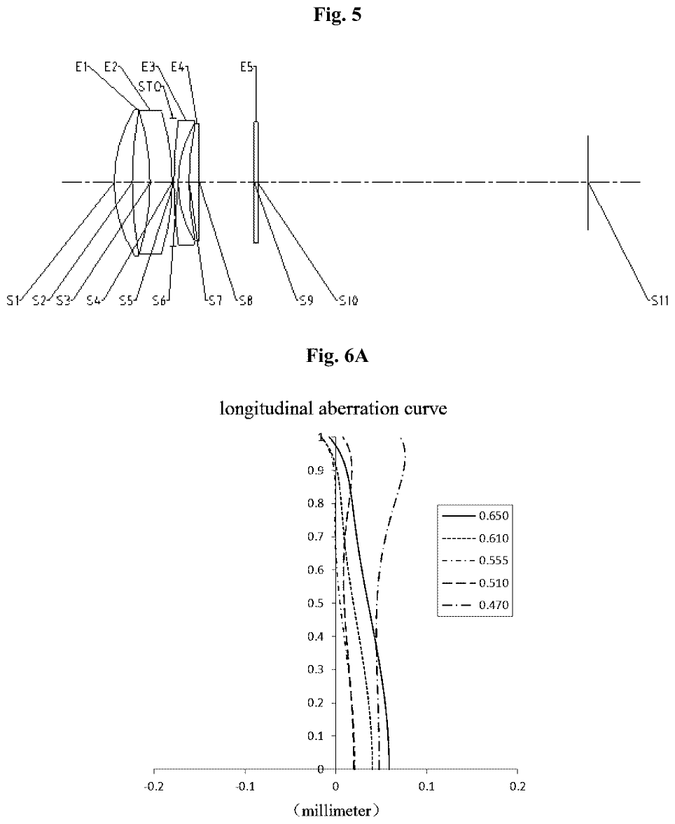

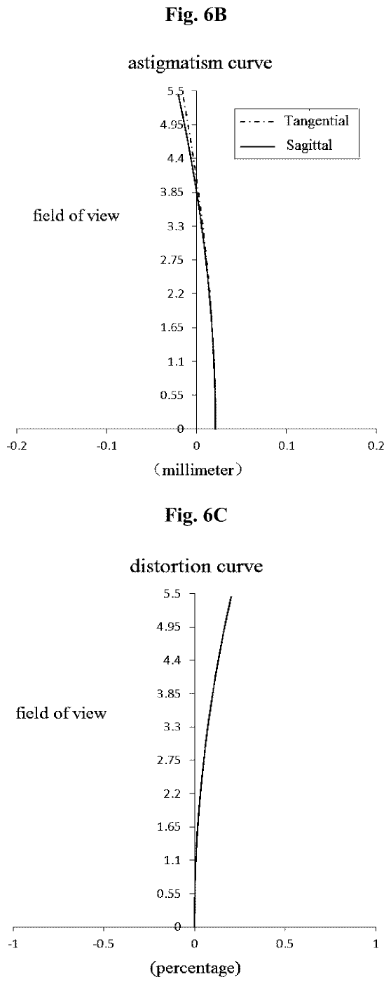

An optical imaging lens assembly according to Embodiment 3 of the disclosure will be described below with reference to FIGS. 5-6C. FIG. 5 shows a structural schematic diagram of an optical imaging lens assembly according to Embodiment 3 of the disclosure.

As shown in FIG. 5, the optical imaging lens assembly sequentially includes from an object side to an image side: a first lens E1, a second lens E2, a diaphragm STO, a third lens E3, a fourth lens E4, an optical filter E5, and an imaging surface S11.

The first lens E1 has a positive refractive power, an object-side surface S1 thereof is a convex surface, and an image-side surface S2 is a concave surface. The second lens E2 has a positive refractive power, an object-side surface S3 thereof is a concave surface, and an image-side surface S4 is a convex surface. The third lens E3 has a negative refractive power, an object-side surface S5 thereof is a convex surface, and an image-side surface S6 is a concave surface. The fourth lens E4 has a positive refractive power, an object-side surface S7 thereof is a convex surface, and an image-side surface S8 is a convex surface. The optical filter E5 has an object-side surface S9 and an image-side surface S10. Light from an object sequentially passes through each of the surfaces S1 to S10 and is finally imaged on the imaging surface S11.

In the embodiment, a total effective focal length f of the optical imaging lens assembly is 28.10 mm. TTL is a total length of the optical imaging lens assembly, and TTL is 27.50 mm. ImgH is a half of a diagonal length of an effective pixel region on the imaging surface S11 of the optical imaging lens assembly, and ImgH is 2.71 mm. FOV is a maximum field of view of the optical imaging lens assembly, and FOV is 11.0°.

Table 3 shows a basic parameter table of the optical imaging lens assembly of Embodiment 3, wherein the units of the curvature radius, the thickness/distance, the focal length and the effective semi-diameter are all millimeters (mm).

TABLE 3

| Surface | Surface | Curvature | Thickness/ | | Refractive | Abbe | Focal | Effective |
|---|---|---|---|---|---|---|---|---|
| number | type | radius | distance | Material | index | number | length | semi-diameter |
| OBJ | Spherical | Infinite | Infinite | | | | | |
| S1 | Spherical | 8.1295 | 1.0500 | Glass | 2.01 | 29.1 | 11.89 | 4.2453 |
| S2 | Spherical | 23.6715 | 1.0313 | | | | | 4.1693 |
| S3 | Spherical | −13.8632 | 1.2828 | Glass | 2.01 | 29.1 | 296.38 | 4.1572 |
| S4 | Spherical | −13.8631 | 0.0500 | | | | | 4.0811 |
| STO | Spherical | Infinite | 0.0500 | | | | | 3.6864 |
| S5 | Spherical | 26.0461 | 0.2438 | Glass | 1.93 | 20.9 | −9.54 | 3.5902 |
| S6 | Spherical | 6.5943 | 0.6385 | | | | | 3.3622 |
| S7 | Spherical | 16.6162 | 0.5964 | Glass | 1.76 | 52.3 | 21.64 | 3.3704 |
| S8 | Spherical | −1200.0000 | 3.1707 | | | | | 3.3665 |
| S9 | Spherical | Infinite | 0.2100 | Glass | 1.52 | 64.2 | | 3.5000 |
| S10 | Spherical | Infinite | 19.1765 | | | | | 3.5000 |
| S11 | Spherical | Infinite | | | | | | 2.7295 |

FIG. 6A shows a longitudinal aberration curve of the optical imaging lens assembly according to Embodiment 3 to represent deviations of a convergence focal point after light with different wavelengths passes through the lens. FIG. 6B shows an astigmatism curve of the optical imaging lens assembly according to Embodiment 3 to represent a tangential image surface curvature and a sagittal image surface curvature. FIG. 6C shows a distortion curve of the optical imaging lens assembly according to Embodiment 3 to represent distortion values corresponding to different fields of view. According to FIGS. 6A-6C, it can be seen that the optical imaging lens assembly provided in Embodiment 3 may achieve high imaging quality.

### Embodiment 4

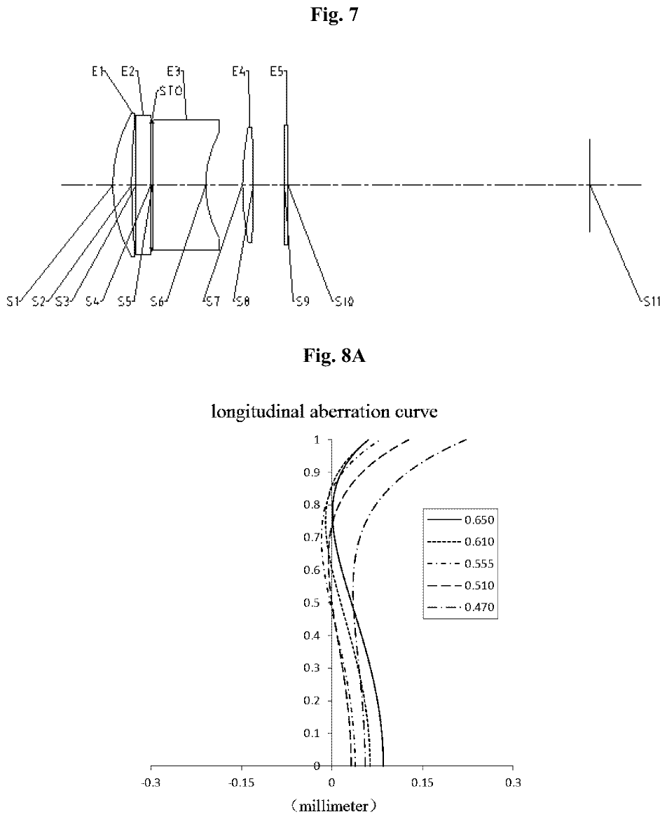

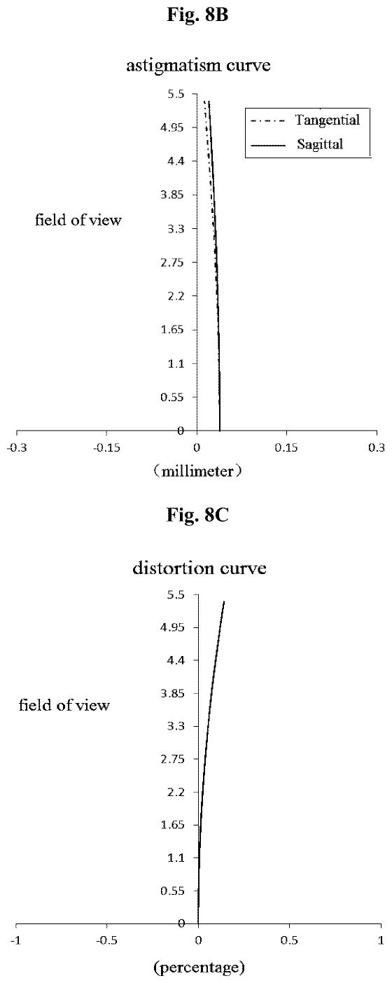

An optical imaging lens according to Embodiment 4 of the disclosure will be described below with reference to FIGS. 7-8C. FIG. 7 shows a structural schematic diagram of an optical imaging lens assembly according to Embodiment 4 of the disclosure.

As shown in FIG. 7, the optical imaging lens assembly sequentially includes from an object side to an image side: a first lens E1, a second lens E2, a diaphragm STO, a third lens E3, a fourth lens E4, an optical filter E5, and an imaging surface S11.

The first lens E1 has a positive refractive power, an object-side surface S1 thereof is a convex surface, and an image-side surface S2 is a concave surface. The second lens E2 has a negative refractive power, an object-side surface S3 thereof is a concave surface, and an image-side surface S4 is a convex surface. The third lens E3 has a negative refractive power, an object-side surface S5 thereof is a convex surface, and an image-side surface S6 is a concave surface. The fourth lens E4 has a positive refractive power, an object-side surface S7 thereof is a convex surface, and an image-side surface S8 is a convex surface. The optical filter E5 has an object-side surface S9 and an image-side surface S10. Light from an object sequentially passes through each of the surfaces S1 to S10 and is finally imaged on the imaging surface S11.

In the embodiment, a total effective focal length f of the optical imaging lens assembly is 28.50 mm. TTL is a total length of the optical imaging lens assembly, and TTL is 28.00 mm. ImgH is a half of a diagonal length of an effective pixel region on the imaging surface S11 of the optical imaging lens assembly, and ImgH is 2.71 mm. FOV is a maximum field of view of the optical imaging lens assembly, and FOV is 10.9°.

Table 4 shows a basic parameter table of the optical imaging lens assembly of Embodiment 4, wherein the units of the curvature radius, the thickness/distance, the focal length and the effective semi-diameter are all millimeters (mm).

TABLE 4

| Surface | Surface | Curvature | Thickness/ | | Refractive | Abbe | Focal | Effective |
|---|---|---|---|---|---|---|---|---|
| number | type | radius | distance | Material | index | number | length | semi-diameter |
| OBJ | Spherical | Infinite | Infinite | | | | | |
| S1 | Spherical | 8.6201 | 1.1075 | Glass | 2.01 | 29.1 | 10.56 | 4.1858 |
| S2 | Spherical | 42.5226 | 0.2642 | | | | | 4.1158 |
| S3 | Spherical | −501.5770 | 0.8593 | Glass | 2.01 | 29.1 | −1000.00 | 4.0884 |
| S4 | Spherical | −1000.0000 | 0.0500 | | | | | 3.8861 |
| STO | Spherical | Infinite | 0.0500 | | | | | 3.6672 |
| S5 | Spherical | 121.1125 | 3.1167 | Glass | 1.93 | 20.9 | −7.35 | 3.8293 |
| S6 | Spherical | 6.3966 | 2.1609 | | | | | 3.1105 |
| S7 | Spherical | 17.5331 | 0.6366 | Glass | 1.76 | 52.3 | 19.25 | 3.3574 |
| S8 | Spherical | −85.2452 | 1.8284 | | | | | 3.3570 |
| S9 | Spherical | Infinite | 0.2100 | Glass | 1.52 | 64.2 | | 3.5000 |
| S10 | Spherical | Infinite | 17.7164 | | | | | 3.5000 |
| S11 | Spherical | Infinite | | | | | | 2.7423 |

FIG. 8A shows a longitudinal aberration curve of the optical imaging lens assembly according to Embodiment 4 to represent deviations of a convergence focal point after light with different wavelengths passes through the lens. FIG. 8B shows an astigmatism curve of the optical imaging lens assembly according to Embodiment 4 to represent a tangential image surface curvature and a sagittal image surface curvature. FIG. 8C shows a distortion curve of the optical imaging lens assembly according to Embodiment 4 to represent distortion values corresponding to different fields of view. According to FIGS. 8A-8C, it can be seen that the optical imaging lens assembly provided in Embodiment 4 may achieve high imaging quality.

### Embodiment 5

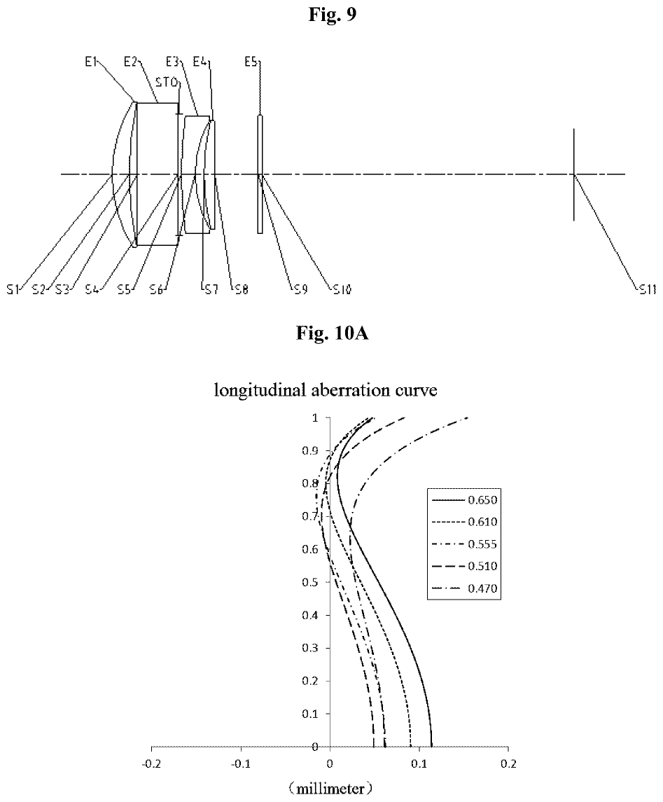

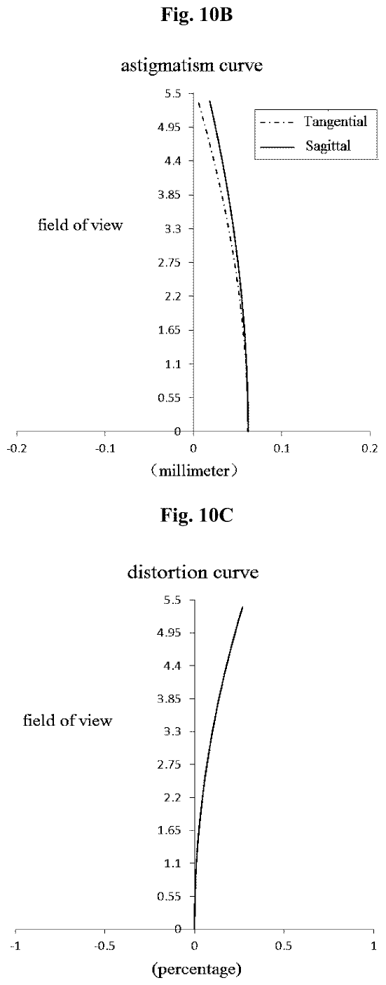

An optical imaging lens according to Embodiment 5 of the disclosure will be described below with reference to FIGS. 9-10C. FIG. 9 shows a structural schematic diagram of an optical imaging lens assembly according to Embodiment 5 of the disclosure.

As shown in FIG. 9, the optical imaging lens assembly sequentially includes from an object side to an image side: a first lens E1, a second lens E2, a diaphragm STO, a third lens E3, a fourth lens E4, an optical filter E5, and an imaging surface S11.

The first lens E1 has a positive refractive power, an object-side surface S1 thereof is a convex surface, and an image-side surface S2 is a concave surface. The second lens E2 has a negative refractive power, an object-side surface S3 thereof is a convex surface, and an image-side surface S4 is a concave surface. The third lens E3 has a negative refractive power, an object-side surface S5 thereof is a convex surface, and an image-side surface S6 is a concave surface. The fourth lens E4 has a positive refractive power, an object-side surface S7 thereof is a convex surface, and an image-side surface S8 is a convex surface. The optical filter E5 has an object-side surface S9 and an image-side surface S10. Light from an object sequentially passes through each of the surfaces S1 to S10 and is finally imaged on the imaging surface S11.

In the embodiment, a total effective focal length f of the optical imaging lens assembly is 28.50 mm. TTL is a total length of the optical imaging lens assembly, and TTL is 27.30 mm. ImgH is a half of a diagonal length of an effective pixel region on the imaging surface S11 of the optical imaging lens assembly, and ImgH is 2.71 mm. FOV is a maximum field of view of the optical imaging lens assembly, and FOV is 10.9°.

Table 5 shows a basic parameter table of the optical imaging lens assembly of Embodiment 5, wherein the units of the curvature radius, the thickness/distance, the focal length and the effective semi-diameter are all millimeters (mm).

TABLE 5

| Surface | Surface | Curvature | Thickness/ | | Refractive | Abbe | Focal | Effective |
|---|---|---|---|---|---|---|---|---|
| number | type | radius | distance | Material | index | number | length | semi-diameter |
| OBJ | Spherical | Infinite | Infinite | | | | | |
| S1 | Spherical | 8.1960 | 0.9938 | Glass | 2.01 | 29.1 | 13.24 | 4.3011 |
| S2 | Spherical | 19.9690 | 0.4893 | | | | | 4.2239 |
| S3 | Spherical | 2347.5890 | 2.3887 | Glass | 2.01 | 29.1 | −226.49 | 4.2043 |
| S4 | Spherical | 207.8145 | 0.0816 | | | | | 3.6668 |
| STO | Spherical | Infinite | 0.1269 | | | | | 3.6029 |
| S5 | Spherical | 25.2321 | 0.8180 | Glass | 1.93 | 20.9 | −9.63 | 3.4831 |
| S6 | Spherical | 6.5091 | 0.5321 | | | | | 3.2156 |
| S7 | Spherical | 13.9757 | 0.6279 | Glass | 1.76 | 52.3 | 18.24 | 3.2252 |
| S8 | Spherical | −1200.0000 | 2.5691 | | | | | 3.2221 |
| S9 | Spherical | Infinite | 0.2100 | Glass | 1.52 | 64.2 | | 3.5000 |
| S10 | Spherical | Infinite | 18.4626 | | | | | 3.5000 |
| S11 | Spherical | Infinite | | | | | | 2.7342 |

FIG. 10A shows a longitudinal aberration curve of the optical imaging lens assembly according to Embodiment 5 to represent deviations of a convergence focal point after light with different wavelengths passes through the lens. FIG. 10B shows an astigmatism curve of the optical imaging lens assembly according to Embodiment 5 to represent a tangential image surface curvature and a sagittal image surface curvature. FIG. 10C shows a distortion curve of the optical imaging lens assembly according to Embodiment 5 to represent distortion values corresponding to different image heights. According to FIGS. 10A-10C, it can be seen that the optical imaging lens assembly provided in Embodiment 5 may achieve high imaging quality.

### Embodiment 6

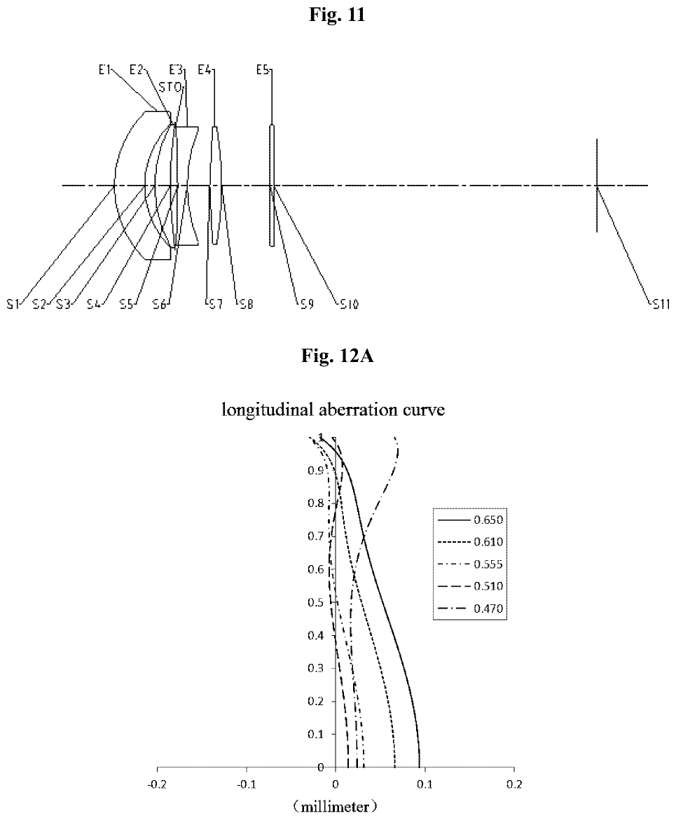

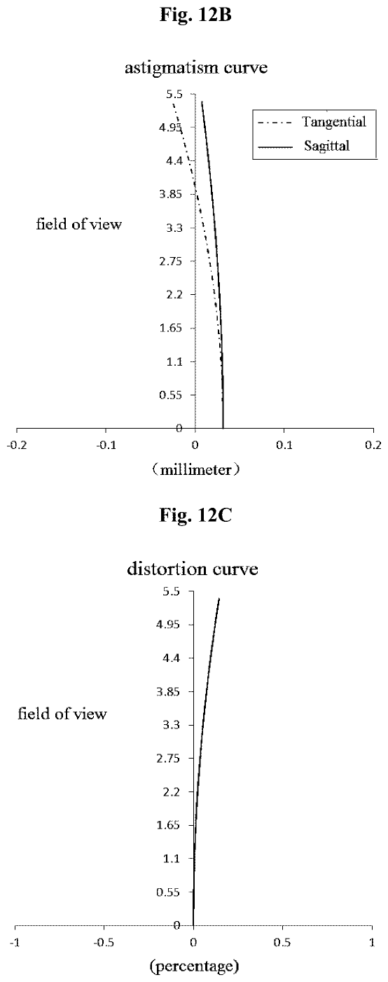

An optical imaging lens assembly according to Embodiment 6 of the disclosure will be described below with reference to FIGS. 11-12C. FIG. 11 shows a structural schematic diagram of an optical imaging lens assembly according to Embodiment 6 of the disclosure.

As shown in FIG. 11, the optical imaging lens assembly sequentially includes from an object side to an image side: a first lens E1, a second lens E2, a diaphragm STO, a third lens E3, a fourth lens E4, an optical filter E5, and an imaging surface S11.

The first lens E1 has a negative refractive power, an object-side surface S1 thereof is a convex surface, and an image-side surface S2 is a concave surface. The second lens E2 has a positive refractive power, an object-side surface S3 thereof is a convex surface, and an image-side surface S4 is a concave surface. The third lens E3 has a negative refractive power, an object-side surface S5 thereof is a concave surface, and an image-side surface S6 is a concave surface. The fourth lens E4 has a positive refractive power, an object-side surface S7 thereof is a convex surface, and an image-side surface S8 is a convex surface. The optical filter E5 has an object-side surface S9 and an image-side surface S10. Light from an object sequentially passes through each of the surfaces S1 to S10 and is finally imaged on the imaging surface S11.

In the embodiment, a total effective focal length f of the optical imaging lens assembly is 28.50 mm. TTL is a total length of the optical imaging lens assembly, and TTL is 27.90 mm. ImgH is a half of a diagonal length of an effective pixel region on the imaging surface S11 of the optical imaging lens assembly, and ImgH is 2.71 mm. FOV is a maximum field of view of the optical imaging lens assembly, and FOV is 10.9°.

Table 6 shows a basic parameter table of the optical imaging lens assembly of Embodiment 6, wherein the units of the curvature radius, the thickness/distance, the focal length and the effective semi-diameter are all millimeters (mm).

TABLE 6

| Surface | Surface | Curvature | Thickness/ | | Refractive | Abbe | Focal | Effective |
|---|---|---|---|---|---|---|---|---|
| number | type | radius | distance | Material | index | number | length | semi-diameter |
| OBJ | Spherical | Infinite | Infinite | | | | | |
| S1 | Spherical | 5.9874 | 1.7580 | Glass | 2.01 | 29.1 | −279.02 | 4.2584 |
| S2 | Spherical | 4.9987 | 0.5778 | | | | | 3.5363 |
| S3 | Spherical | 7.1866 | 0.8940 | Glass | 2.01 | 29.1 | 10.13 | 3.5322 |
| S4 | Spherical | 22.7898 | 0.3095 | | | | | 3.4580 |
| STO | Spherical | Infinite | 0.1324 | | | | | 3.4014 |
| S5 | Spherical | −69.8739 | 0.5466 | Glass | 1.93 | 20.9 | −8.13 | 3.4094 |
| S6 | Spherical | 8.5161 | 1.2943 | | | | | 3.2260 |
| S7 | Spherical | 33.8321 | 0.7025 | Glass | 1.76 | 52.3 | 16.53 | 3.3746 |
| S8 | Spherical | −19.6978 | 2.7908 | | | | | 3.3883 |
| S9 | Spherical | Infinite | 0.2100 | Glass | 1.52 | 64.2 | | 3.5000 |
| S10 | Spherical | Infinite | 18.6841 | | | | | 3.5000 |
| S11 | Spherical | Infinite | | | | | | 2.7199 |

FIG. 12A shows a longitudinal aberration curve of the optical imaging lens assembly according to Embodiment 6 to represent deviations of a convergence focal point after light with different wavelengths passes through the lens. FIG. 12B shows an astigmatism curve of the optical imaging lens assembly according to Embodiment 6 to represent a tangential image surface curvature and a sagittal image surface curvature. FIG. 12C shows a distortion curve of the optical imaging lens assembly according to Embodiment 6 to represent distortion values corresponding to different fields of view. According to FIGS. 12A-12C, it can be seen that the optical imaging lens assembly provided in Embodiment 6 may achieve high imaging quality.

### Embodiment 7

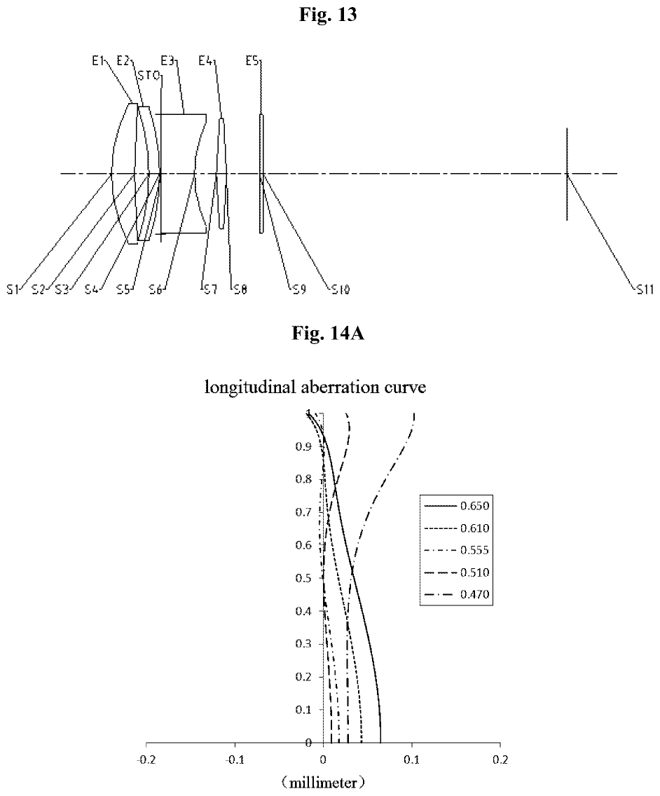

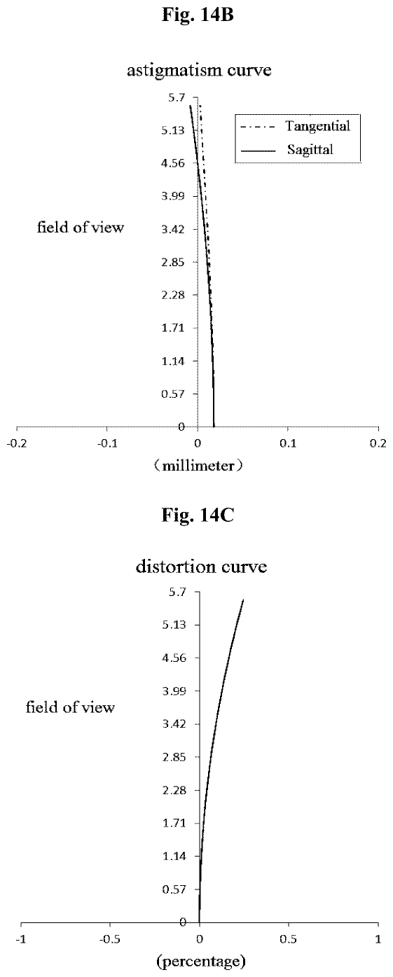

An optical imaging lens assembly according to Embodiment 7 of the disclosure will be described below with reference to FIGS. 13-14C. FIG. 13 shows a structural schematic diagram of an optical imaging lens assembly according to Embodiment 7 of the disclosure.

As shown in FIG. 13, the optical imaging lens assembly sequentially includes from an object side to an image side: a first lens E1, a second lens E2, a diaphragm STO, a third lens E3, a fourth lens E4, an optical filter E5, and an imaging surface S11.

The first lens E1 has a positive refractive power, an object-side surface S1 thereof is a convex surface, and an image-side surface S2 is a concave surface. The second lens E2 has a positive refractive power, an object-side surface S3 thereof is a concave surface, and an image-side surface S4 is a convex surface. The third lens E3 has a negative refractive power, an object-side surface S5 thereof is a concave surface, and an image-side surface S6 is a concave surface. The fourth lens E4 has a positive refractive power, an object-side surface S7 thereof is a convex surface, and an image-side surface S8 is a convex surface. The optical filter E5 has an object-side surface S9 and an image-side surface S10. Light from an object sequentially passes through each of the surfaces S1 to S10 and is finally imaged on the imaging surface S11.

In the embodiment, a total effective focal length f of the optical imaging lens assembly is 27.50 mm. TTL is a total length of the optical imaging lens assembly, and TTL is 27.00 mm. ImgH is a half of a diagonal length of an effective pixel region on the imaging surface S11 of the optical imaging lens assembly, and ImgH is 2.71 mm. FOV is a maximum field of view of the optical imaging lens assembly, and FOV is 11.2°.

Table 7 shows a basic parameter table of the optical imaging lens assembly of Embodiment 7, wherein the units of the curvature radius, the thickness/distance, the focal length and the effective semi-diameter are all millimeters (mm).

TABLE 7

| Surface | Surface | Curvature | Thickness/ | | Refractive | Abbe | Focal | Effective |
|---|---|---|---|---|---|---|---|---|
| number | type | radius | distance | Material | index | number | length | semi-diameter |
| OBJ | Spherical | Infinite | Infinite | | | | | |
| S1 | Spherical | 8.9132 | 1.3511 | Glass | 2.01 | 29.1 | 10.83 | 4.1324 |
| S2 | Spherical | 45.0299 | 0.8634 | | | | | 3.9782 |
| S3 | Spherical | −12.3110 | 0.6428 | Glass | 2.01 | 29.1 | 380.45 | 3.9600 |
| S4 | Spherical | −12.2404 | 0.0500 | | | | | 3.9255 |
| STO | Spherical | Infinite | 0.0563 | | | | | 3.5338 |
| S5 | Spherical | −1000.0000 | 1.9614 | Glass | 1.93 | 20.9 | −7.73 | 3.5197 |
| S6 | Spherical | 7.2538 | 1.2839 | | | | | 3.1122 |
| S7 | Spherical | 27.5568 | 0.6151 | Glass | 1.76 | 52.3 | 18.83 | 3.2267 |
| S8 | Spherical | −29.2817 | 1.9561 | | | | | 3.2348 |
| S9 | Spherical | Infinite | 0.2100 | Glass | 1.52 | 64.2 | | 3.5000 |
| S10 | Spherical | Infinite | 18.0099 | | | | | 3.5000 |
| S11 | Spherical | Infinite | | | | | | 2.7322 |

FIG. 14A shows a longitudinal aberration curve of the optical imaging lens assembly according to Embodiment 7 to represent deviations of a convergence focal point after light with different wavelengths passes through the lens. FIG. 14B shows an astigmatism curve of the optical imaging lens assembly according to Embodiment 7 to represent a tangential image surface curvature and a sagittal image surface curvature. FIG. 14C shows a distortion curve of the optical imaging lens assembly according to Embodiment 7 to represent distortion values corresponding to different fields of view. According to FIGS. 14A-14C, it can be seen that the optical imaging lens assembly provided in Embodiment 7 may achieve high imaging quality.

From the above, Embodiment 1 to Embodiment 7 satisfy a relationship shown in Table 8 respectively.

TABLE 8

| Conditional expression/embodiment | 1 | 2 | 3 | 4 | 5 | 6 | 7 |
|---|---|---|---|---|---|---|---|
| TTL/f | 0.97 | 0.94 | 0.98 | 0.98 | 0.96 | 0.98 | 0.98 |
| f (mm) | 28.20 | 29.80 | 28.10 | 28.50 | 28.50 | 28.50 | 27.50 |
| (f3 + f4)/f | 0.42 | 0.43 | 0.43 | 0.42 | 0.30 | 0.29 | 0.40 |
| (R7 − R6)/(R7 + R6) | 0.34 | 0.35 | 0.43 | 0.47 | 0.36 | 0.60 | 0.58 |
| R1/R2 | 0.37 | 0.43 | 0.34 | 0.20 | 0.41 | 1.20 | 0.20 |
| (N1 + N2 + N3 + N4)/4 | 1.93 | 1.93 | 1.93 | 1.93 | 1.93 | 1.93 | 1.93 |
| (T12 + T23 + T34)/(CT1 + CT2 + CT3) | 0.59 | 0.39 | 0.69 | 0.50 | 0.29 | 0.72 | 0.57 |
| SL/TTL | 0.87 | 0.88 | 0.88 | 0.92 | 0.86 | 0.87 | 0.89 |
| BFL/f | 0.80 | 0.78 | 0.80 | 0.69 | 0.75 | 0.76 | 0.73 |
| (SAG11 + SAG12)/ImgH | 0.61 | 0.59 | 0.58 | 0.47 | 0.62 | 1.20 | 0.44 |
| (SAG41 − SAG42)/CT4 | 0.59 | 0.53 | 0.59 | 0.61 | 0.61 | 0.66 | 0.60 |
| FOV (°) | 11.0 | 10.4 | 11.0 | 10.9 | 10.9 | 10.9 | 11.2 |

The disclosure also provides an imaging device, of which an electronic photosensitive element may be a Charge Coupled Device (CCD) or a Complementary Metal Oxide Semiconductor (CMOS). The imaging device may be an independent imaging device such as a digital camera, or may be an imaging module integrated into a mobile electronic device such as a mobile phone. The imaging device is provided with the above-mentioned optical imaging lens assembly.

The above description is only description about the preferred embodiments of the disclosure and adopted technical principles. It is understood by those skilled in the art that the scope of invention involved in the disclosure is not limited to the technical solutions formed by specifically combining the technical features and should also cover other technical solutions formed by freely combining the technical features or equivalent features thereof without departing from the inventive concept, for example, technical solutions formed by mutually replacing the features and (but not limited to) the technical features with similar functions disclosed in the disclosure.

What is claimed is:

1. An optical imaging lens assembly, sequentially comprising from an object side to an image side along an optical axis:
a first lens with a refractive power,
a second lens with a refractive power,
a third lens with a negative refractive power, and
a fourth lens with a positive refractive power,
wherein a total effective focal length f of the optical imaging lens assembly satisfies 20 mm<f<30 mm.

2. The optical imaging lens assembly according to claim 1, wherein TTL is a distance from an object-side surface of the first lens to an imaging surface of the optical imaging lens assembly on the optical axis, and the total effective focal length f of the optical imaging lens assembly and TTL satisfy TTL/f<1.2.

3. The optical imaging lens assembly according to claim 1, wherein an effective focal length f3 of the third lens, an effective focal length f4 of the fourth lens and the total effective focal length f of the optical imaging lens assembly satisfy 0.1<(f3+f4)/f<0.6.

4. The optical imaging lens assembly according to claim 1, wherein a curvature radius R7 of an object-side surface of the fourth lens and a curvature radius R6 of an image-side surface of the third lens satisfy 0.3<(R7−R6)/(R7+R6)<0.7.

5. The optical imaging lens assembly according to claim 1, wherein a curvature radius R1 of an object-side surface of the first lens and a curvature radius R2 of an image-side surface of the first lens satisfy 0.1<R1/R2<1.3.

6. The optical imaging lens assembly according to claim 1, wherein a refractive index N1 of the first lens, a refractive index N2 of the second lens, a refractive index N3 of the third lens and a refractive index N4 of the fourth lens satisfy 1.8<(N1+N2+N3+N4)/4<2.1.

7. The optical imaging lens assembly according to claim 1, wherein a spacing distance T12 of the first lens and the second lens on the optical axis, a spacing distance T23 of the second lens and the third lens on the optical axis, a spacing distance T34 of the third lens and the fourth lens on the optical axis, a center thickness CT1 of the first lens on the optical axis, a center thickness CT2 of the second lens on the optical axis and a center thickness CT3 of the third lens on the optical axis satisfy 0.2<(T12+T23+T34)/(CT1+CT2+CT3)<0.8.

8. The optical imaging lens assembly according to claim 1, further comprising a diaphragm,
wherein SL is a distance from the diaphragm to an imaging surface of the optical imaging lens assembly on the optical axis, TTL is a distance from an object-side surface of the first lens to the imaging surface on the optical axis, and SL and TTL satisfy 0.8<SL/TTL<1.0.

9. The optical imaging lens assembly according to claim 1, wherein BFL is a distance from an image-side surface of the fourth lens to an imaging surface of the optical imaging lens assembly on the optical axis, and BFL and the total effective focal length f of the optical imaging lens assembly satisfy 0.65<BFL/f<0.85.

10. The optical imaging lens assembly according to claim 1, wherein SAG11 is a distance from an intersection point of an object-side surface of the first lens and the optical axis to an effective radius vertex of the object-side surface of the first lens on the optical axis, SAG12 is a distance from an intersection point of an image-side surface of the first lens and the optical axis to an effective radius vertex of the image-side surface of the first lens on the optical axis, ImgH is a half of a diagonal length of an effective pixel region on an imaging surface of the optical imaging lens assembly, and SAG11, SAG12 and ImgH satisfy 0.4<(SAG11+SAG12)/ImgH<1.3.

11. The optical imaging lens assembly according to claim 1, wherein SAG41 is a distance from an intersection point of an object-side surface of the fourth lens and the optical axis to an effective radius vertex of the object-side surface of the fourth lens on the optical axis, SAG42 is a distance from an intersection point of an image-side surface of the fourth lens and the optical axis to an effective radius vertex of the image-side surface of the fourth lens on the optical axis, and SAG41, SAG42 and a center thickness CT4 of the fourth lens on the optical axis may satisfy 0.5<(SAG41−SAG42)/CT4<0.7.

12. The optical imaging lens assembly according to claim 1, wherein at least two lenses of the first lens to the fourth lens are made of a glass material.

13. The optical imaging lens assembly according to claim 1, wherein object-side surfaces and image-side surfaces of at least two lenses of the first lens to the fourth lens are spherical.

14. The optical imaging lens assembly according to claim 1, wherein FOV is a maximum field of view of the optical imaging lens assembly, and FOV satisfies FOV<15°.
